(19) United States
(12) Patent Application Publication
(10) Pub. No.: US 2019/0005377 A1
(43) Pub. Date: Jan. 3, 2019

(54) ARTIFICIAL NEURAL NETWORK REDUCTION TO REDUCE INFERENCE COMPUTATION TIME

(71) Applicant: Advanced Micro Devices, Inc., Sunnyvale, CA (US)

(72) Inventor: Nicholas Malaya, Austin, TX (US)

(73) Assignee: Advanced Micro Devices, Inc., Sunnyvale, CA (US)

(21) Appl. No.: 15/638,993

(22) Filed: Jun. 30, 2017

(51) Int. Cl. G06N 3/04; G06N 5/02; G06N 5/04

(52) U.S. Cl. CPC G06N 3/0427; G06N 5/025; G06F 17/11; G06N 5/046; G06N 5/043

(57) ABSTRACT

Training devices and methods for training an artificial neural network (ANN). The training device includes processing circuitry configured to transmit training data for the ANN and parameters for the ANN to an inference device. The processing circuitry is also configured to receive inference data, based on the training data and the parameters, from the inference device. The processing circuitry is also configured to receive inference timing information, based on the training data and the parameters, from the inference device. The processing circuitry is also configured to calculate a difference between the calculated inference data and expected inference data. The processing circuitry is also configured to modify the parameters and to transmit the modified parameters to the inference device if the difference exceeds a difference threshold or if the timing information indicates an inference time exceeding a timing threshold

### BACKGROUND

An artificial neural network (ANN) is a computing device or system inspired by the way biological nervous systems, such as brains, process information. An ANN includes an interconnected group of nodes (i.e., artificial neurons). The nodes are interconnected by links. Each node can receive input data, perform operations on the data, and pass the results on to other nodes. The output of a node can be referred to as its activation, or node value. Each of the links is associated with a weight. The ANN can be trained by inputting a training data set, having a known correct output, to generate an output inference. The output inference can be compared to the known correct input, and the difference, if any, can be used to adjust the weights. This procedure can be performed iteratively to converge on an optimized weighting for the ANN based on that training data set.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating a graphics processing pipeline, according to an example;

FIG. 4 is a system diagram illustrating an example system for training an ANN;

FIG. 5 is a flow chart illustrating an example method for training an ANN using the system of FIG. 4;

FIG. 6a is a schematic which illustrates an example ANN;

FIG. 6b is a schematic which illustrates the example ANN of FIG. 6a after a pruning operation; and

FIG. 7 is a flow chart illustrating another example method for training an ANN using the system of FIG. 4.

### DETAILED DESCRIPTION

Some embodiments provide a device for training an artificial neural network (ANN). The device for training the ANN includes processing circuitry configured to transmit training data for the ANN and parameters for the ANN to an inference device. The processing circuitry is also configured to receive inference data, based on the training data and the parameters, from the inference device. The processing circuitry is also configured to receive inference timing information, based on the training data and the parameters, from the inference device. The processing circuitry is also configured to calculate a difference between the calculated inference data and expected inference data. The processing circuitry is also configured to modify the parameters and to transmit the modified parameters to the inference device if the difference exceeds a difference threshold or if the timing information indicates an inference time exceeding a timing threshold.

In some embodiments, the parameters include a weight, a vector of weights for artificial neurons of the ANN, a vector specifying connections between artificial neurons, or a vector of features of the ANN. In some embodiments, the device for training the ANN and the inference device share the processing circuitry. In some embodiments, the device for training the ANN includes a memory which includes a non-transitory computer readable medium.

Some embodiments provide a method for training an artificial neural network (ANN) using a device for training the ANN. The method includes transmitting training data for the ANN and parameters for the ANN to an inference device; receiving inference data, based on the training data and the parameters, from the inference device; receiving inference timing information, based on the training data and the parameters, from the inference device; calculating a difference between the calculated inference data and expected inference data; and modifying the parameters and transmitting the modified parameters to the inference device if the difference exceeds a difference threshold or if the timing information indicates an inference time exceeding a timing threshold.

In some embodiments, the parameters include a weight, a vector of weights for artificial neurons of the ANN, a vector specifying connections between artificial neurons, or a vector of features of the ANN. In some embodiments, the device for training the ANN and the inference device share processing circuitry. In some embodiments, device for training the ANN and the inference device share a non-transitory computer readable medium.

Some embodiments provide a method for training an artificial neural network (ANN). The method includes receiving training data for the ANN and parameters for the ANN from a device for training the ANN; transmitting inference data, based on the training data and the parameters, to the device for training the ANN; transmitting inference timing information, based on the training data and the parameters, to the device for training the ANN; and receiving modified parameters from the device for training the ANN based on the inference data and the inference timing information.

In some embodiments, the parameters comprise a weight, a vector of weights for artificial neurons of the ANN, a vector specifying connections between artificial neurons, or a vector of features of the ANN. In some embodiments, the device for training the ANN and the inference device share processing circuitry or a non-transitory computer readable medium.

Improvements in machine learning have historically been focused on advances in training approaches versus advances in inference approaches, because training is the more computationally complex part of the evaluation.

Both training of and inference by artificial neural networks (ANNs) begin with the same forward propagation calculation. The training phase also includes a backpropagation calculation. Backpropagation can be accomplished through a series of matrix manipulations (e.g., convolutions.) Significant efforts have been made to develop efficient convolution operators, which are a core computational kernel and can be used for fast neural network training and evaluation.

ANN processing implementations have demonstrated that tuned fully custom software libraries that provide common artificial learning algorithms and primitive functions can achieve high performance with very high GPU utilization. Thus, the speed of inference tasks can be increased by either reducing the computational work needed to perform the inference calculation, or by increasing the speed of the inference hardware. For example, in some implementations either halving the amount of work performed or doubling the speed of computing halves the time to perform the computation.

The same network that was used to minimize the residual error of the data is typically then also used for the inference evaluations. However, with new hardware products explicitly configured for use as inference devices (and not configured for use in training) there now exists an opportunity to emphasize the effective computation of inference tasks in machine learning. Furthermore, inference calculations potentially use a different objective function than training operations.

For instance, inference tasks can be time critical. Training is seldom performed in real-time, but inference often is. Examples of time sensitive inference tasks include intra-market stock trading, defensive driving in autonomous cars, and anomaly/fraud detection in credit card transactions. These observations can be leveraged in a new approach to ANN training via reinforcement learning, with the objective of reducing the computational intensity of the inference evaluation.

Typically, reinforcement learning is initiated after a supervised learning training phase. However in various implementations discussed herein, the trained network is altered and then compared to its previous version to derive new weights or other parameters for the network that closely mimics output of the network as previously trained, but optimized for computational efficiency.

It may be desired to build a simpler network that captures features and responses of the fully trained network, while providing superior performance when implemented on an inference specific device. The simplified ANN can reduce inference time with respect to the fully trained network while minimizing or mitigating the loss of accuracy which might potentially result from a simpler network. To understand expected performance, the optimization can be performed in a manner which is hardware aware, e.g., optimized for register size of a target inference device, as opposed to the register size of the device for training the ANN (hereinafter, ‘training device’), as inference devices and training devices can have significantly different characteristics.

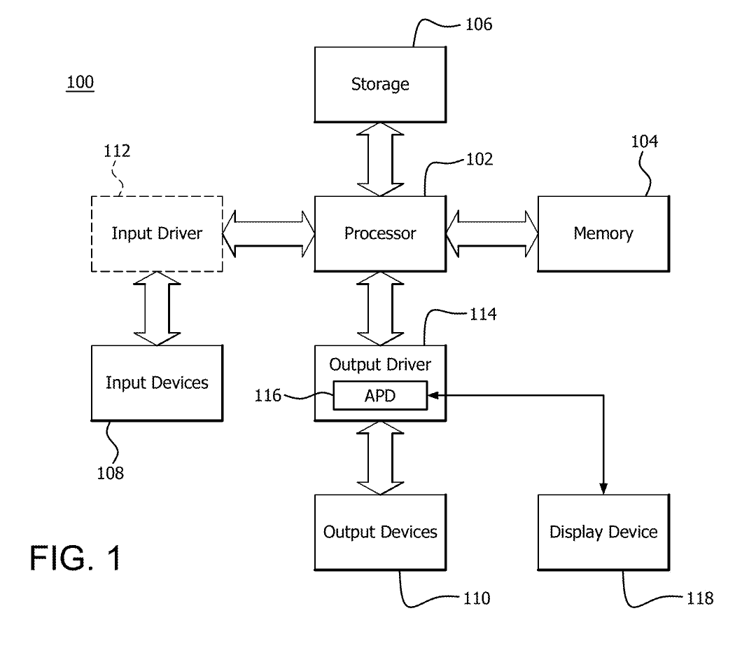

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is be located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide graphical output to a display device 118. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

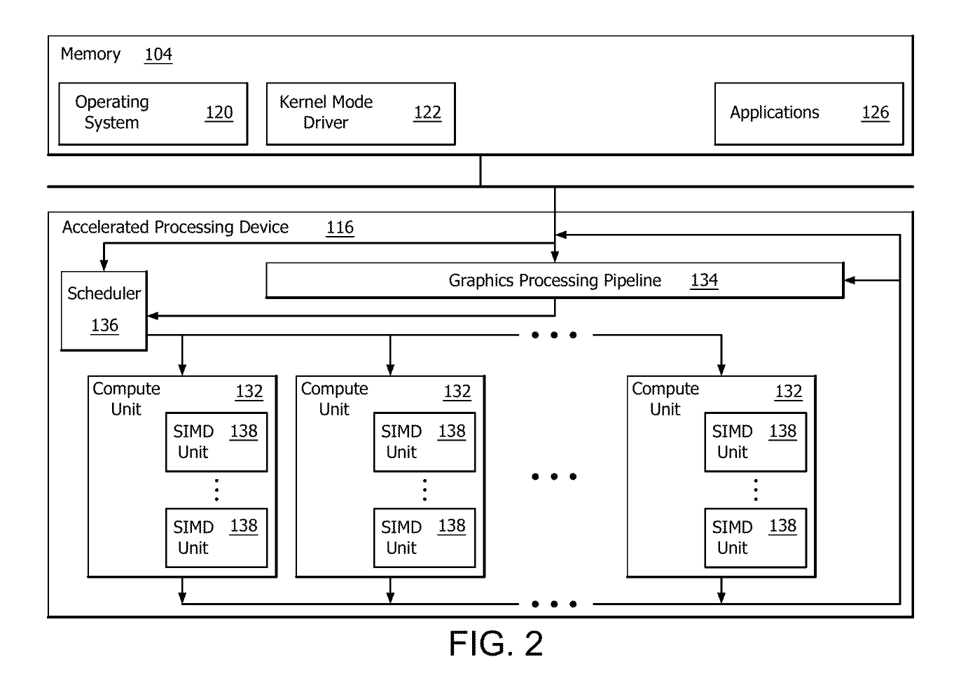

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that are suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 is configured to perform operations related to scheduling various wavefronts on different compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

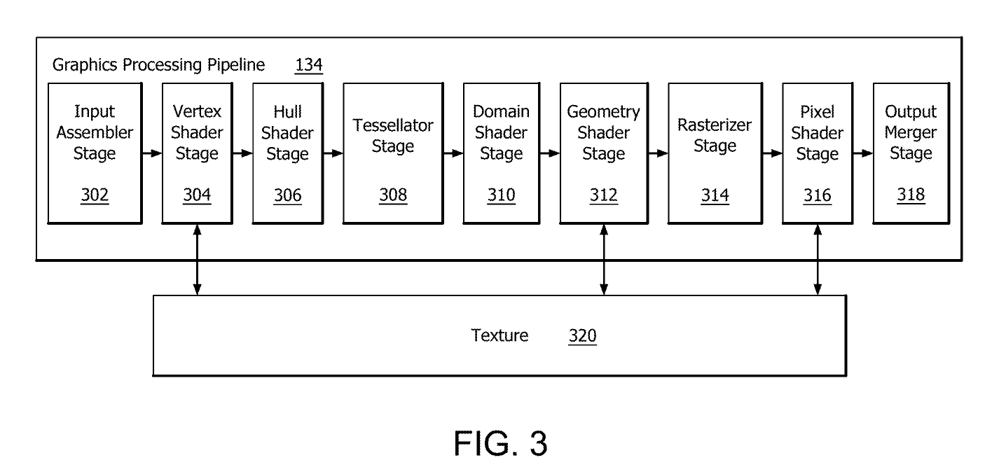

FIG. 3 is a block diagram showing additional details of the graphics processing pipeline 134 illustrated in FIG. 2. The graphics processing pipeline 134 includes stages that each performs specific functionality. The stages represent subdivisions of functionality of the graphics processing pipeline 134. Each stage is implemented partially or fully as shader programs executing in the programmable processing units 202, or partially or fully as fixed-function, non-programmable hardware external to the programmable processing units 202.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertexes of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations. Herein, such transformations are considered to modify the coordinates or “position” of the vertices on which the transforms are performed. Other operations of the vertex shader stage 304 modify attributes other than the coordinates.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the programmable processing units 202.

The geometry shader stage 312 performs vertex operations on a primitive-by-primitive basis. A variety of different types of operations can be performed by the geometry shader stage 312, including operations such as point sprint expansion, dynamic particle system operations, fur-fin generation, shadow volume generation, single pass render-to-cubemap, per-primitive material swapping, and per-primitive material setup. In some instances, a shader program that executes on the programmable processing units 202 perform operations for the geometry shader stage 312.

The rasterizer stage 314 accepts and rasterizes simple primitives and generated upstream. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a shader program that executes on the programmable processing units 202.

The output merger stage 318 accepts output from the pixel shader stage 316 and merges those outputs, performing operations such as z-testing and alpha blending to determine the final color for a screen pixel.

Texture data, which defines textures, are stored and/or accessed by the texture unit 320. Textures are bitmap images that are used at various points in the graphics processing pipeline 134. For example, in some instances, the pixel shader stage 316 applies textures to pixels to improve apparent rendering complexity (e.g., to provide a more “photorealistic” look) without increasing the number of vertices to be rendered.

In some instances, the vertex shader stage 304 uses texture data from the texture unit 320 to modify primitives to increase complexity, by, for example, creating or modifying vertices for improved aesthetics. In one example, the vertex shader stage 304 uses a height map stored in the texture unit 320 to modify displacement of vertices. This type of technique can be used, for example, to generate more realistic looking water as compared with textures only being used in the pixel shader stage 316, by modifying the position and number of vertices used to render the water. In some instances, the geometry shader stage 312 accesses texture data from the texture unit 320.

In order to optimize or improve an ANN through training, it is useful to describe how well the ANN draws inferences, e.g., using a cost function. A cost function in this context is typically a function which returns a value representing how closely the output of the ANN matches a known correct output based on an example set of input information.

To improve or optimize the ANN, parameters of the model can be modified to minimize the cost function. This can be referred to as training the ANN. For example, the ANN can be iteratively adjusted until the cost function reaches a desired value, or for a desired number of iterations. In a more specific example, the weights of all or a subset of the artificial neurons of the ANN can be adjusted or perturbed at each iteration (e.g., randomly, or using a search algorithm). The following equation illustrates an example cost function:

$${min}_{∀ θ = {R}^{n}} J ( \vec{θ} ) = ‖ f ( \vec{θ} \vec{x} ) - \vec{d} ‖ \qquad Equation 1$$

where:
[symbol] is a vector containing weights for each of the neurons in the ANN.
[symbol] is a vector containing features of the ANN. Features, in this context, refers to inputs to the ANN.
f( [symbol] ) is the non-linear activation function of the neural network.
[symbol] is a vector containing training data used to calibrate the ANN.

In order to train the ANN represented by the cost function, J( [symbol] ), the neuron weights [symbol] are adjusted to minimize J( [symbol] ). At each iteration, the neuron weights [symbol] are adjusted or perturbed, e.g., randomly. After the neuron weights [symbol] are adjusted, the cost function J( [symbol] ) is calculated, e.g., by running a training inference using the ANN weighted with the current neuron weights neuron weights, [symbol] .

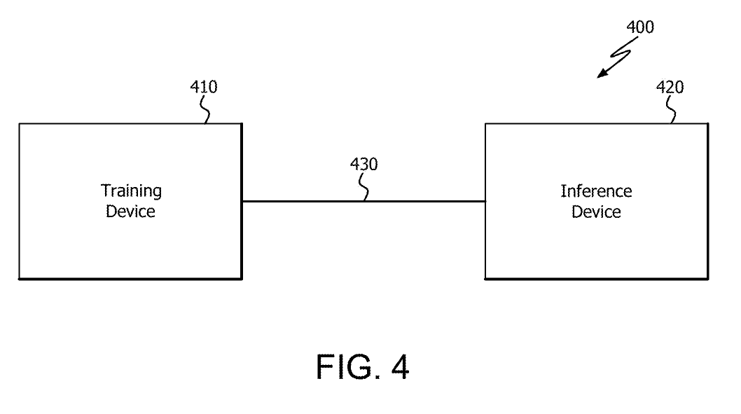

FIG. 4 is a system diagram illustrating an example system 400 for training an ANN. The system of FIG. 4 includes a training device 410, and an inference device 420. Training device 410 is in communication with inference device 420 over a suitable communications medium 430. Training device 410 can include any suitable computing device capable of implementing and altering an ANN, and typically includes processing circuitry and non-transitory computer readable memory in communication with the processing circuitry. For example, training device 410 may be implemented using processor 102 and memory 104 as shown and described with respect to FIG. 1.

Inference device 420 can include any suitable computing device capable of implementing an ANN and performing inference calculations using the ANN. Inference device 420 typically includes processing circuitry and non-transitory computer readable memory in communication with the processing circuitry. For example, training device 410 may be implemented using APD 116 and memory 104 as shown and described with respect to FIGS. 1 and 2. It is noted that in other example implementations, training device 410 and inference device 420 may be implemented in different computing systems, or may be implemented as the same device.

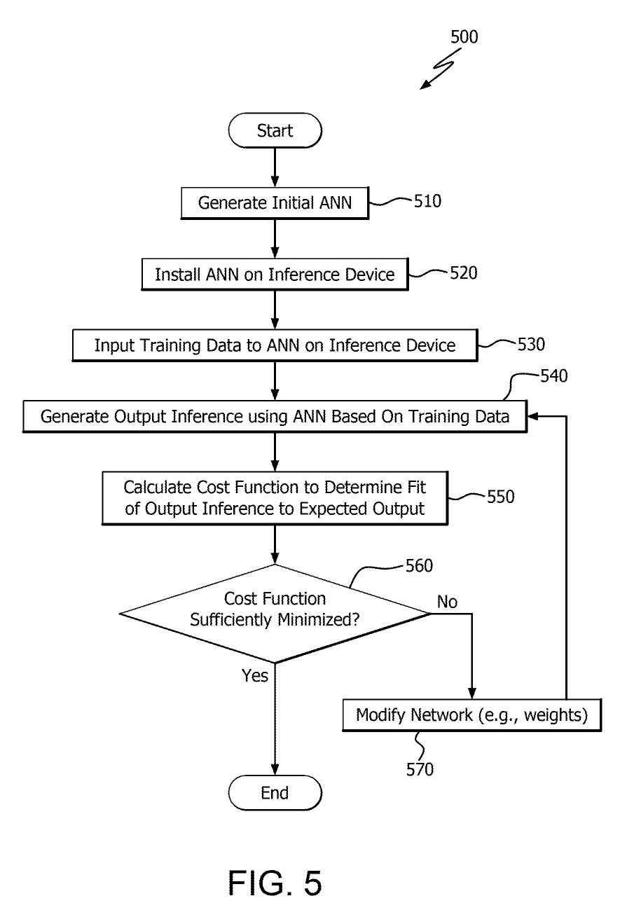

FIG. 5 is a flow chart illustrating an example method 500 for training an ANN using system 400 (shown with respect to FIG. 4). In step 510, an initial ANN, (or initial weights, parameters, features and/or activation functions for an existing ANN) is generated and input to the training device. The ANN (or initial weights, parameters, features and/or activation functions for an existing ANN) can be generated by or in the training device 410, or in another suitable computing device. In some implementations, the ANN comprises one or more layers of interconnected artificial neurons which are in communication with at least one input node and at least one output node of the ANN. The artificial neurons may, for example, each be implemented as a specialized physical device and connected as desired with other such devices, or may, for example, each be implemented as a data structure stored in a memory (e.g., memory 104 as shown and described with respect to FIGS. 1 and 2) with appropriate links (e.g., pointers) to other such data structures. Regardless of implementation, each neuron will include connections to at least one other neuron, will include a weight for each connection, and will express or embody an activation function, which relates its weighted input to its output.

In step 520, the ANN is installed on inference device 420. For example, data structures representing the neurons and their weights and activation functions can be downloaded from training device 420 to inference device 410. If the initial ANN is generated on a different device, it can be downloaded from that device to the inference device 410.

In step 530, training data is input to the ANN on inference device 420. The training data can include any suitable data, such as measured quantities, artificial data generated by algorithms or simulations, expert elicitation, etc. For example, training data may include pixels corresponding to an image, which has been labeled to indicate objects appearing in the image, such as cats or dogs. The training data can also include an initial weighting for each of the neurons in the ANN. The training data can be input from training device 410, or from any other suitable source. It is noted that activation functions for the ANN can also be input to the ANN at this step, or such functions can have been added to or included in the ANN earlier.

In step 540, the inference device 420 generates output (an inference) based on the input training data. This output can be transmitted to the training device 410. In step 550, a cost function is calculated by the training device 410 to determine the fit of the output inference to the expected result based on the input data. The cost function can correspond to Equation 1, or otherwise normalize the cost for accuracy of fit of the output inference to the expected result. On a condition 560 that the cost function indicates a sufficient fit (e.g., based on a threshold determined by a user or in any other suitable manner) between the inference and the expected output, the training ends, and the inference device 420 can generate further inferences based on the ANN and the current weight vector. Otherwise, on a condition 560 that the cost function indicates that the fit between the inference and the expected output is insufficient, the ANN is modified by the training device 410 in step 560. The modification can include, for example, changing or perturbing the weights (either the entire vector or a subset, randomly or otherwise) to generate an updated weight vector. The updated weight vector is used to update the ANN on the inference device, and the flow returns to step 540, where the inference device generates a new output inference based on the input training data and the updated weight vector.

This process can iterate until the cost function is sufficiently minimized. It is noted that while in some implementations the cost function is considered sufficiently minimized when the cost function indicates that the fit between the output inference and the expected output is sufficiently accurate, in other implementations, the cost function can be considered sufficiently minimized after a desired number of iterations, or based on other criteria, e.g., as provided by a heuristic. For example, a random search heuristic can be used to determine parameters by randomly drawing guesses from probability distributions, and has no formal stopping criterion.

Using method 500 with the cost function of Equation 1 to determine condition 560 will result in an ANN which is optimized for or improved in accuracy. However, it may be desired to optimize or improve the ANN for size and/or complexity considerations.

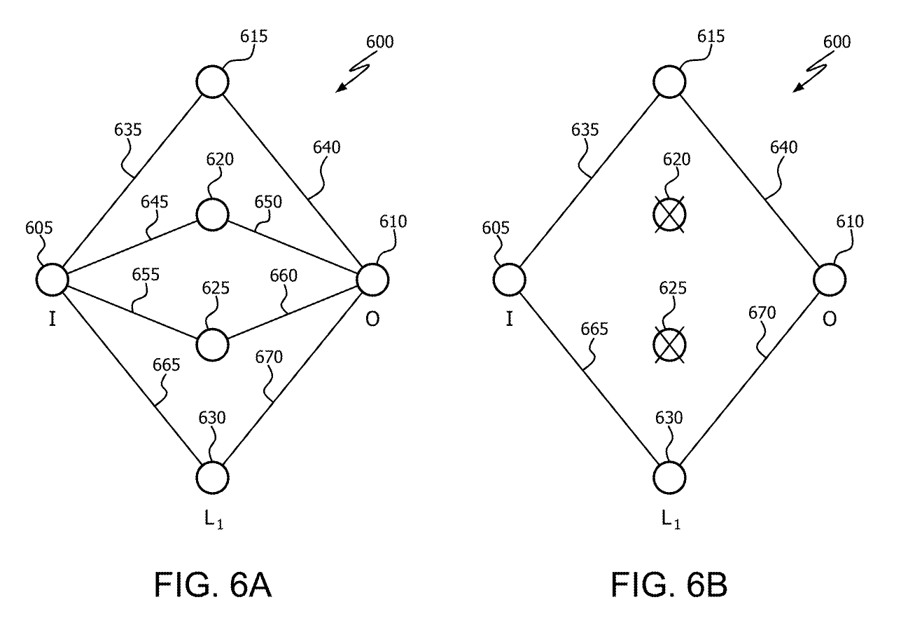

FIG. 6a is a schematic which illustrates an example ANN 600 having an input node 605, an output node 610, neurons 615, 620, 625, 630 in a layer L1 and connections 635, 640, 645, 650, 655, 660, 665, 670 among the neurons, input, and output nodes. It is noted that in other implementations, ANN 600 can have more than one input node, more than one output node, and/or more than one layer of artificial neurons, and the artificial neurons can be connected using any suitable dependency arrangement. FIG. 6b is a schematic which illustrates the same example ANN 600 after removing or “pruning” connections 645, 650, 655, and 660 from ANN 600. This pruning disconnects neurons 620 and 625 from ANN 600, resulting in a reduction in the number of neurons in the ANN. If the cost function after pruning is acceptable following the pruning, the pruned configuration of FIG. 6b can be chosen over the original configuration of FIG. 6a as preferable in view of its reduced complexity. In some implementations, such reduced complexity can yield increased inference speed.

In a training method where, in addition to the weights, the number of features in the ANN can also be modified, a regularization term can be added to the cost calculation in order to increase cost based on the number of features x in (i.e., inputs to) the ANN. In this way, the complexity of the network can be balanced with accuracy in the cost function. An example cost function which reflects regularization based on the number of features (here, by penalizing the weights) is as follows:

$${min}_{∀ θ = {R}^{n}} J ( \vec{θ} ) = ‖ f ( \vec{θ} \vec{x} - \vec{d} ) ‖ + λ ‖ \vec{θ} ‖ \qquad Equation 2$$

where:
λ is a parameter for regularization based on number of features.

Substituting Equation 2 in the calculation for condition 560, we can alter step 570 to also modify and/or perturb the number of features in the ANN (e.g., the number of inputs to the ANN.) By adding the regularization term λ∥ [symbol] ∥, a set of neuron weights [symbol] yielding an output with a certain accuracy of fit can be replaced with a set of neuron weights [symbol] having a similar (or acceptable) accuracy of fit in the next iteration if the number of features is lower, as this will reduce the cost function. It is noted that the regularization based on number of features described above is exemplary; many other types of regularization are possible. For example regularizing based on the smoothness of the weights, adding synthetic data, adding random noise, and semi-supervised learning tasks are possible approaches.

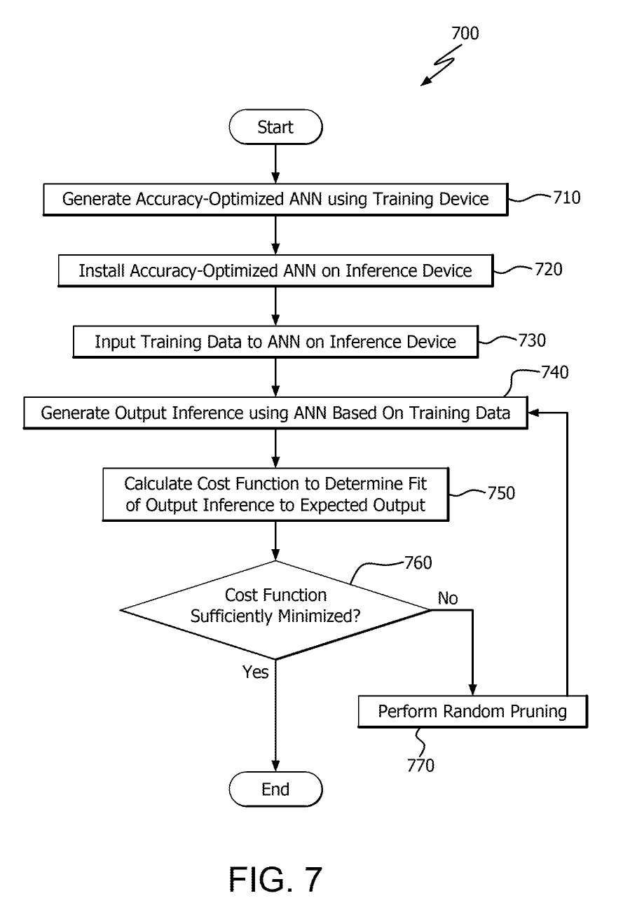

FIG. 7 is a flow chart illustrating an example method 600 for training an ANN using system 400 (shown with respect to FIG. 4). In step 710, an ANN which has been optimized or otherwise processed for accuracy of inference is generated (e.g., via method 500) and input to the training device. The ANN (or accuracy optimized weights, parameters, features and/or activation functions for an existing ANN) can be generated by or in the training device 410, or in another suitable computing device. In some implementations, the ANN comprises one or more layers of interconnected artificial neurons which are in communication with at least one input node and at least one output node of the ANN. The artificial neurons may, for example, each be implemented as a specialized physical device and connected as desired with other such devices, or may, for example, each be implemented as a data structure stored in a memory (e.g., memory 104 shown and described with respect to FIGS. 1 and 2) with appropriate links (e.g., pointers) to other such data structures. Inference calculations and training can be performed on such data structures using suitable processor devices, such as processor 102, and/or APD 116, shown and described with respect to FIGS. 1, 2, and 3. Regardless of implementation, each neuron will include connections to at least one other neuron, will include a weight for each connection, and will express or embody an activation function, which relates its weighted input to its output.

In step 720, the ANN is installed on inference device 420. For example, data structures representing the neurons and their weights and activation functions can be downloaded from training device 420 to inference device 410. If the initial ANN is generated on a different device, it can be downloaded from that device to the inference device 410.

In step 730, training data is input to the ANN on inference device 420. The training data can include, for example, measured quantities, artificial data generated by algorithms or simulations, expert elicitation, etc. For example, training data may include pixels corresponding to an image, which has been labeled to indicate objects appearing in the image, such as cats or dogs. The training data can include an initial weighting for each of the neurons in the ANN. The training data can be input from training device 410, or from any other suitable source. It is noted that activation functions for the ANN can also be input to the ANN at this step, or such functions can have been added to or included in the ANN earlier.

In step 740, the inference device 420 generates output (an inference) based on the input training data. This output can be transmitted to the training device 410. In step 750, a cost function is calculated by the training device 410 to determine the fit of the output inference to the expected result based on the input data. The cost function can correspond to Equation 2, or otherwise normalize the cost for the number of features in the ANN. On a condition 760 that the cost function indicates a sufficient fit between the inference and the expected output, the training ends, and the inference device 420 can generate further inferences based on the ANN and the current complement of features. Otherwise, on a condition 760 that the cost function indicates that the fit between the inference and the expected output is insufficient, the ANN is modified by the training device 410 in step 760. The modification can include, for example, deleting or perturbing connections and/or features (randomly or otherwise) to generate an updated feature vector. The updated feature vector is used to update the ANN on the inference device, and the flow returns to step 740, where the inference device generates a new output inference based on the input training data and the updated weight vector.

This process can iterate until the cost function is sufficiently minimized. It is noted that while in some implementations the cost function is considered sufficiently minimized when the cost function indicates that the fit between the output inference and the expected output is sufficiently accurate, in other implementations, the cost function can be considered sufficiently minimized after a desired number of iterations or based on other criteria, e.g., as provided by a heuristic. For example, a random search heuristic can be used to determine parameters by randomly drawing guesses from probability distributions, and has no formal stopping criterion. Using method 700 with the cost function of Equation 2 to determine condition 760 will result in an ANN which is optimized for or improved in its number of features.

In the examples above, suitable cost functions are used to optimize or improve an ANN for accuracy and/or complexity. It may be observed however that training the ANN to draw the most accurate possible inference can result in a neural network that takes a long time to draw this inference. This can result because the cost function is constructed in a way which values the accuracy of the inference over the speed of the inference.

In some use cases however, it may be desired to draw an inference with a certain desired amount of accuracy but also within a certain amount of time. Example use cases include self-driving cars (e.g., hazard detection applications) or stock trading machines (e.g., automated trading applications). In such cases, it may be desirable to train the ANN to achieve somewhat sub-optimal inference accuracy in order to achieve a desired or optimized speed of inference.

Accordingly, a cost function can be constructed which values the speed of the inference as well as the accuracy of the inference (and potentially other factors). The relative importance of these factors can be weighted or balanced as desired. A regularization term can be added to the cost calculation in order to increase cost based on time to inference in the ANN. In this way, the speed of inference can be balanced with accuracy (and potentially other factors, such as complexity) in the cost function. An example cost function which reflects regularization based on speed of inference is as follows:

$${min}_{∀ θ = {R}^{n}} J ( \vec{θ} ) = ‖ f ( \vec{θ} \vec{x} - \vec{d} ) ‖ + λ ‖ \vec{θ} ‖ + γ ‖ \vec{t} \text{/} \vec{{t}_{0}} ‖ \qquad Equation 3$$

where:
γ is a parameter for regularization based on inference time.
[symbol] is a vector of parameters indicating the time it takes to perform an inference on the inference hardware. This can be a single example (i.e., the vector includes one element indicating a time for one iteration) or many. Each vector element represents an elapsed wall-clock time required to perform an entire computational evaluation through the entire ANN for the iteration in question.
[symbol] is a vector of parameters indicating baseline ANN performance in time for each training case of [symbol] .

Using the method 500 shown and described with respect to FIG. 5, but substituting Equation 3 in the calculation for condition 560, we can alter step 570 to modify and/or perturb both the neuron weights [symbol] and the number of features [symbol] in the ANN (e.g., the number of i.) By adding the inference time regularization term γ∥ [symbol] / [symbol] ∥, a set of neuron weights [symbol] and features [symbol] yielding an output with a certain accuracy of fit can be replaced with a set of neuron weights [symbol] and features x having a similar (or acceptable) accuracy of fit in the next iteration if the inference time is lower, as this will reduce the cost function.

It is understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A device for training an artificial neural network (ANN), the device comprising:
processing circuitry configured to transmit training data for the ANN and parameters for the ANN to an inference device;
the processing circuitry further configured to receive inference data, based on the training data and the parameters, from the inference device;
the processing circuitry further configured to receive inference timing information, based on the training data and the parameters, from the inference device;
the processing circuitry further configured to calculate a difference between the calculated inference data and expected inference data; and
the processing circuitry further configured to modify the parameters and to transmit the modified parameters to the inference device on a condition that the difference exceeds a difference threshold or on a condition that the timing information indicates an inference time exceeding a timing threshold.

2. The device of claim 1, wherein the parameters comprise a weight.

3. The device of claim 1, wherein the parameters comprise a vector of weights for artificial neurons of the ANN.

4. The device of claim 1, wherein the parameters comprise a vector specifying connections between artificial neurons.

5. The device of claim 1, wherein the parameters comprise a vector of features of the ANN.

6. The device of claim 1, wherein the training device and the inference device share the processing circuitry.

7. The device of claim 1, wherein the training device comprises a memory which includes a non-transitory computer readable medium.

8. A method for training an artificial neural network (ANN) using a device for training the ANN, the method comprising:
transmitting training data for the ANN and parameters for the ANN to an inference device;
receiving inference data, based on the training data and the parameters, from the inference device;
receiving inference timing information, based on the training data and the parameters, from the inference device;
calculating a difference between the calculated inference data and expected inference data; and
modifying the parameters and transmitting the modified parameters to the inference device on a condition that the difference exceeds a difference threshold or on a condition that the timing information indicates an inference time exceeding a timing threshold.

9. The method of claim 8, wherein the parameters comprise a weight.

10. The method of claim 8, wherein the parameters comprise a vector of weights for artificial neurons of the ANN.

11. The method of claim 8, wherein the parameters comprise a vector specifying connections between artificial neurons.

12. The method of claim 8, wherein the parameters comprise a vector of features of the ANN.

13. The method of claim 8, wherein the training device and the inference device share processing circuitry.

14. The method of claim 8, wherein the training device and the inference device share a non-transitory computer readable medium.

15. A method for training an artificial neural network (ANN), the method comprising:
receiving training data for the ANN and parameters for the ANN from a device for training the ANN;
transmitting inference data, based on the training data and the parameters, to the training device;
transmitting inference timing information, based on the training data and the parameters, to the device for training the ANN; and
receiving modified parameters from the device for training the ANN based on the inference data and the inference timing information.

16. The method of claim 15, wherein the parameters comprise a weight.

17. The method of claim 15, wherein the parameters comprise a vector of weights for artificial neurons of the ANN.

18. The method of claim 15, wherein the parameters comprise a vector specifying connections between artificial neurons.

19. The method of claim 15, wherein the parameters comprise a vector of features of the ANN.

20. The method of claim 15, wherein the device for training the ANN and the inference device share processing circuitry or a non-transitory computer readable medium.
